(19) United States
(12) Patent Application Publication
(10) Pub. No.: US 2008/0163777 A1
(43) Pub. Date: Jul. 10, 2008

(54) Security Kit and Security Ink

(75) Inventors: Eckhardt Bock, Kuerten (DE); Bengt-Thomas Grobel, Waldems (DE); Valker Paulat, Marne (DE); Konrad Bootz, Wetter (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 11/908,978

(22) PCT Filed: Mar. 15, 2006
(86) PCT No.: PCT/EP2006/060768

§ 371 Date: Nov. 9, 2007

(30) Foreign Application Priority Data
Mar. 19, 2005 (DE) 10 2005 012 747.9

(51) Int. Cl. B41F 31/00; C09D 11/00

(52) U.S. Cl. 101/491; 106/31.27

(57) ABSTRACT

The present invention relates to a security kit which comprises a security ink and a decoder substrate, the security ink comprising at least one colorant and at least one marker substance, colorant and marker substance having opposite solubilities, and the decoder substrate being able to take up the marker substance, and also to a security ink.

The present invention relates to a security kit which comprises a security ink and a decoder substrate, the security ink comprising a colorant and a marker substance, colorant and marker substance having opposite solubilities, and the decoder substrate being able to take up the marker substance.

In numerous sectors there is great interest in ensuring the authenticity of documents. One known method of protecting against counterfeits is to use additional, secondary information whose inconspicuousness renders it unperceived by the naked eye. Also known is the use, in printing methods and/or printing fluids, of organic molecules which can be excited to fluorescence, thereby likewise increasing the anticounterfeit security. These processes, however, have the disadvantage either that they require very expensive and/or complex apparatus or else that, on account of their low specificity, they are unable to offer the sharp differentiation that is necessary for precise identification.

It is an object of the present invention, therefore, to provide means and methods affording sufficient specificity.

It has now surprisingly been found that this object is achieved by providing first a security ink and second a decoder substrate having properties which are described below.

The present invention relates to a security kit which comprises a security ink and a decoder substrate, the security ink comprising at least one colorant and at least one marker substance, colorant and marker substance having opposite solubilities, and the decoder substrate being able to take up the marker substance.

Suitable colorants are, generally, all colorants which are employed, for instance, in inks.

Suitability is thus possessed by water-insoluble colorants, such as quinacridone, phthalocyanine, azo, dioxazine, indigoid, isoindolinone, perylene and perinone, and also pyrrolopyrrole pigments or disperse, solvent or vat dyes. Particular preference is given to C.I. Pigment Blue 15:4, C.I. Pigment Red 122, and C.I. Pigment Yellow 74, C.I. Disperse Blue 60, C.I. Disperse Red 92, C.I. Disperse Yellow 114, and, especially, Carbon Black.

Also suitable, however, are colorants which have very good water-solubility but are sparingly soluble or insoluble in hydrocarbons such as toluene, acetone, chloroform, ligroin, hexane, cyclohexane, ethyl acetoacetate, diethyl ether, ethanol, methanol or methylene chloride, for example. Examples of such colorants are C.I. Reactive Black 8 and 31, C.I. Reactive Red 23, 120, 141, and 180, C.I. Direct Blue 86 and 199, C.I. Direct Yellow 86 and 132, C.I. Direct Black 168, C.I. Acid Yellow 23, C.I. Acid Red 52, C.I. Acid Black 194, and C.I. Food Black 2.

Marker substances for the purposes of the present specification are, for example, soluble substances, for instance water-soluble dyes such as C.I. Acid Yellow 83, for example, or soluble fluorescent compounds, especially optical brighteners, or else organic compounds which are able to act as a coupling component in an azo coupling reaction—that is, which react with a diazonium salt to form an azo dye. Preferred optical brighteners are, in particular, commercial products which belong, for instance, to the diaminostilbenedisulfonic acids, heteroaromatic ethylene derivatives, coumarins, diarylpyrazolines, naphthylimides, quinolones or benzoxazole, benzisoxazole, and benzimidazole systems. Additionally it is possible to use with advantage strongly fluorescing compounds from the product classes of the triazoles and the benzothiazoles. As an example, mention may be made of 7-amino-2-(4-amino-2-sulfophenyl)-2H-naphtho[1,2-d][1,2,3]-triazole-5,9-disulfonic acid or 2-(4-aminophenyl)-6-methylbenzothiazole.

Coupling components which can act as marker substances in the sense of the present invention originate in particular from the series of the pyridones, pyrazolones, aminobenzene derivatives, hydroxybenzene derivatives, aminonaphthalene derivatives, and hydroxynaphthalene derivatives.

Preferred marker substances in the sense of the present specification are water-insoluble compounds, such as, for instance, commercial optical brighteners for plastics and synthetic fibers, such as C.I. Fluorescent Brighteners 127, 184, 199, and 393, and also other strongly fluorescing substances which are free from water-solubilizing substituents such as sulfonic or carboxylic acid groups (for example, C.I. Solvent Yellow 160), and also, in particular, water-soluble substances, such as commercial optical brighteners for cellulose fibers such as cotton and paper, such as C.I. Fluorescent Brighteners 85, 113, 186, 190, 220, and 260, and also other strongly fluorescing substances which possess water-solubility substituents such as sulfonic or carboxylic acid groups.

Colorant and marker substance must have opposite solubilities. In the context of the present invention this means that, if the colorant, for example, is insoluble in water, the marker substance must be water-soluble, and that the marker substance must be water-insoluble if the colorant is water-soluble.

The as-claimed security inks are preferably aqueous inks comprising a water-insoluble colorant and, accordingly, a water-soluble marker substance. Particularly preferred as-claimed security inks are commercial carbon black inks comprising as their marker substance a fluorescent compound or an organic compound able to act as a coupling component in an azo coupling reaction. Additionally, carbon black inks which comprise as their marker substance a mixture of a fluorescent compound and an organic compound able to act as a coupling component in an azo coupling reaction are particularly preferred.

The amount of marker substance in this case is preferably 0.01 to 2% by weight, based on the total weight of the security ink.

The decoder substrate in the context of the present invention is a substrate which is able to take up the marker substance and on which the marker substance is visible or can be visualized. This includes the decoder substrate being absorbent and hence able to bind water and/or organic liquids in which the marker substance is dissolved. Preferred decoder substrates are sheetlike textile or nontextile substrates. Particularly preferred sheetlike textile substrates are, for example, those made of cellulose, cotton, wool, silk, polyamide (nylon), polyacrylonitrile, polypropylene or polyester. Particularly preferred sheetlike nontextile substrates are, for example, those made of paper, polyester, polyurethane, rubber, nitrocellulose, and leather. An especially preferred decoder substrate is filter paper.

The security kit of the invention is advantageously used by printing or inscribing an inscribable or printable substrate, such as paper or a sheetlike plastics substrate, with the security ink.

Where the document thus produced is to be tested for authenticity, the marker substance is transferred to the decoder substrate from a small area of the text or of the print, and is visible or is visualized on the decoder substrate.

The transfer and visualization of the marker substance is dependent on that substance. If, for example, the marker substance used is a water-soluble fluorescent compound, then a preferred decoder substrate is filter paper, which is moistened with water and intimately contacted with the test substrate for a few seconds. The marker substance which has diffused onto the decoder substrate can be identified by exposure to UV light and assignment of the characteristic fluorescence. If the marker substance used is an organic compound able to act as a coupling component in an azo coupling reaction, transfer to a moistened filter paper is likewise appropriate. Contact then takes place thereon with a suitable diazonium salt (for example, a commercial fast salt), followed by characterization of the azo dye developed.

Depending on the marker substance, further detection methods can also be employed. One example that may be mentioned is that of NIR spectroscopy.

The security kit of the invention may comprise not only security ink and decoder substrate but also further means. Examples of such further means include means necessary to the detection of the marker substance—for example, diazonium salts (fast salts) for detecting an organic compound able to act as a coupling component in an azo coupling reaction.

Also possible is a solvent or solvent mixture with which the decoder substrate can be impregnated and the marker substance can be extracted from the document under test.

Some of the as-claimed security inks are known. For example, the Abstract of KR 10 2004 0060393 A describes inks which in addition to insoluble pigments also contain fluorescent dyes. In contrast, security inks comprising as their marker substance an organic compound able to act as a coupling component in an azo coupling reaction are still new.

The present invention hence accordingly provides an aqueous security ink which comprises at least one water-insoluble colorant and an organic compound able to act as a coupling component in an azo coupling reaction.

Preferred water-insoluble colorants and organic compounds able to act as a coupling component in an azo coupling reaction are the colorants and compounds, respectively, identified above as being preferred.

The security inks of the invention contain colorants in amounts of, for example, 0.1% by weight to 50%, preferably in amounts of 1% to 30%, and more preferably in amounts of 1% to 15%, by weight, based on the total weight of the ink.

The organic compound able to act as a coupling component in an azo coupling reaction must be present in the security ink of the invention at least in an amount sufficient to permit reliable detection of the azo dye developed on the decoder substrate.

Normally 0.01% to 2% by weight, based on the total weight of the security ink, is sufficient for this purpose.

The security inks of the invention can of course also comprise further auxiliaries and additives customary in inks. The skilled worker is aware of these auxiliaries and additives.

The advantages of the security kit of the invention lie in particular in its ease of use, since the testing of a document for authenticity can be carried out virtually anywhere without great technical expense or complexity. Nor are there any special requirements regarding the production of the information carrier, because, for example, the process described allows marked documents to be produced using commercial printer papers and printers, without further pretreatment. On the other hand, without subsequent identification by means of the decoder substrate, the marking is unrecognizable, and consequently it is not immediately apparent that the product is marked at all.

The examples below serve to illustrate the invention.

### EXAMPLE 1

100 g of a commercial black ink based on carbon black are admixed with 1 g of C.I. Fluorescent Brightener 220. The authenticity of a document printed with this ink is ensured by pressing a cotton cloth moistened with a little water onto a printed area of the document for approximately 5 seconds. The imprint on the cotton cloth is visualized under UV light.

### EXAMPLE 2

100 g of a commercial pigment ink based on C.I. Pigment Blue 15:4, C.I. Pigment Red 122, and C.I. Pigment Yellow 74 are admixed with 0.1 g of C.I. Fluorescent Brightener 260. The authenticity of a document printed with this ink is ensured by pressing a cellulosic filter paper moistened with a little water onto a printed area of the document for approximately 5 seconds. The imprint on the cellulosic filter paper is visualized under UV light.

### EXAMPLE 3

100 g of a commercial ink based on carbon black are admixed with 0.5 g of 7-amino-2-(4-amino-2-sulfophenyl)-2H-naphtho[1,2-d][1,2,3]triazole-5,9-disulfonic acid. The authenticity of a document printed with this ink is ensured by pressing a wool cloth moistened with a little water onto a printed area of the document for approximately 5 seconds. The imprint on the wool cloth is visualized under UV light.

### EXAMPLE 4

100 g of a commercial ink based on C.I. Disperse Blue 60, C.I. Disperse Red 92, and C.I. Disperse Yellow 114 are admixed with 0.5 g of C.I. Fluorescent Brightener 260. The authenticity of a document printed with this ink is ensured by pressing a cellulosic filter paper moistened with a little water onto a printed area of the document for approximately 5 seconds. The imprint on the cellulosic filter paper is visualized under UV light.

### EXAMPLE 5

100 g of a commercial ink based on carbon black are admixed with 0.1 g of C.I. Fluorescent Brightener 186 and 1 g of 4-amino-5-hydroxynaphthalene-2,7-disulfonic acid. The authenticity of a document printed with this ink is ensured by pressing a cellulosic filter paper moistened with a little water onto a printed area of the document for approximately 5 seconds. The imprint on the cellulosic filter paper is visualized under UV light. The filter paper is subsequently coated with an aqueous solution of Fast Scarlet VD salt. A red dye is developed.

### EXAMPLE 6

100 g of a commercial water-soluble ink are admixed with 0.2 g of C.I. Fluorescent Brightener 127. The authenticity of a document printed with this ink is ensured by pressing a cellulosic filter paper moistened with a little acetone onto a printed area of the document for approximately 5 seconds. The imprint on the cellulosic filter paper is visualized under UV light. Additionally the marker substance is identified via an NIR spectroscopy record.

### EXAMPLE 7

100 g of a commercial water-soluble ink are admixed with 0.5 g of C.I. Solvent Yellow 160. The authenticity of a document printed with this ink is ensured by pressing a cellulosic filter paper moistened with a little toluene onto a printed area of the document for approximately 5 seconds. On the filter paper there is a greenish yellow dye which fluoresces under UV light.

### EXAMPLE 8

100 g of a commercial water-soluble ink are admixed with 0.2 g of 2-(4-aminophenyl)-6-methylbenzothiazole. The authenticity of a document printed with this ink is ensured by pressing a nitrocellulose strip onto a printed area of the document for approximately 5 seconds. The imprint on the nitrocellulose strip is visualized under UV light.

### EXAMPLE 9

100 g of a commercial ink based on carbon black are admixed with 0.5 g of C.I. Acid Yellow 83. The authenticity of a document printed with this ink is ensured by pressing a polyamide (nylon) cloth moistened with a little water onto a printed area of the document for approximately 5 seconds. On the cloth there is a greenish yellow dye which fluoresces under UV light.

1-8. (canceled)

9. A security kit which comprises a security ink and a decoder substrate, the security ink comprising at least one colorant and at least one marker substance, wherein the colorant and the marker substance having opposite solubilities, and the decoder substrate being able to take up the marker substance.

10. The security kit as claimed in claim 9, wherein said colorant is quinacridone, phthalocyanine, azo, dioxazine, indigoid, isoindolinone, perylene, perinone, pyrrolopyrrole pigment, a disperse dye, a solvent dye or vat dye.

11. The security kit as claimed in claim 9, wherein said colorant is carbon black.

12. The security kit as claimed in claim 9, wherein the marker substance comprises a soluble fluorescent compound or an organic compound able to act as a coupling component in an azo coupling reaction.

13. The security kit as claimed in claim 10, wherein the marker substance comprises a soluble fluorescent compound or an organic compound able to act as a coupling component in an azo coupling reaction.

14. The security kit as claimed in claim 11, wherein the marker substance comprises a soluble fluorescent compound or an organic compound able to act as a coupling component in an azo coupling reaction.

15. The security kit as claimed in claim 9, wherein the decoder substrate comprises a sheetlike textile substrate made of cellulose, cotton, wool, silk, polyamide (nylon), polyacrylonitrile, polypropylene or polyester or sheetlike nontextile substrate made of paper, polyester, polyurethane, rubber, nitrocellulose or leather.

16. The security kit as claimed in claim 12, wherein the decoder substrate comprises a sheetlike textile substrate made of cellulose, cotton, wool, silk, polyamide (nylon), polyacrylonitrile, polypropylene or polyester or sheetlike nontextile substrate made of paper, polyester, polyurethane, rubber, nitrocellulose or leather.

17. The security kit as claimed in claim 13, wherein the decoder substrate comprises a sheetlike textile substrate made of cellulose, cotton, wool, silk, polyamide (nylon), polyacrylonitrile, polypropylene or polyester or sheetlike nontextile substrate made of paper, polyester, polyurethane, rubber, nitrocellulose or leather.

18. The security kit as claimed in claim 14, wherein the decoder substrate comprises a sheetlike textile substrate made of cellulose, cotton, wool, silk, polyamide (nylon), polyacrylonitrile, polypropylene or polyester or sheetlike nontextile substrate made of paper, polyester, polyurethane, rubber nitrocellulose or leather.

19. An aqueous security ink comprising at least one water-insoluble colorant and an organic compound able to act as a coupling component in an azo coupling reaction.

20. The aqueous security ink as claimed in claim 19, wherein the organic compound able to act as a coupling component in an azo coupling reaction is a compound selected from the series consisting of the pyridones, pyrazolones, aminobenzene derivatives, hydroxybenzene derivatives, aminonaphthalene derivatives and hydroxynaphthalene derivatives.

21. A method of inscribing or printing a document using a security kit which comprises inscribing or printing a document with a security ink and the document thus produced is tested for authenticity by transferring the marker substance onto the decoder substrate from a small area of the text or print, the marker substance being visible or visualized thereon and wherein the security kit comprises a security ink and a decoder substrate, the security ink comprising at least one colorant and at least one marker substance, wherein the colorant and the marker substance having opposite solubilities, and the decoder substrate being able to take up the marker substance
